(19) United States
(12) Patent Application Publication
(10) Pub. No.: US 2020/0074481 A1
(43) Pub. Date: Mar. 5, 2020

(54) SYSTEM, METHOD, AND DEVICE FOR ANALYZING MEDIA ASSET DATA

(71) Applicant: Greenlight Essentials, Kitchener (CA)

(72) Inventor: Si Chang ZHANG, Kitchener (CA)

(21) Appl. No.: 16/162,852

(22) Filed: Oct. 17, 2018

Related U.S. Application Data
(60) Provisional application No. 62/723,721, filed on Aug. 28, 2018.

(51) Int. Cl. G06Q 30/02; H04N 21/258; G06F 17/30

(52) U.S. Cl. CPC G06Q 30/0201; G06Q 30/0205; G06F 17/30958; H04N 21/25883; G06Q 30/0203

(57) ABSTRACT

Provided herein is a system, a method, and a device for analyzing media asset data. The system includes a memory storing a media asset data, including media expectation data, media performance data, a user input device for receiving user input of a media characteristic, a processor configured to generate a media performance prediction from the media expectation data, the media performance data, and the media characteristic, and a display for displaying the media performance prediction.

### TECHNICAL FIELD

The embodiments disclosed herein relate to media asset data, and, in particular to systems, methods and devices for analyzing media asset data.

### INTRODUCTION

Financing an entertainment project can be challenging as it's very hard to predict the financial performance and public reception of an entertainment project. For example, in the film industry, significant upfront capital is required to produce and distribute a film. However, acquiring the upfront capital to finance the production and distribution of a film is difficult because it is very difficult to predict the financial performance of a film. Various factors contribute to the financial success of a film, including the actors and actresses that are featured in the film, the plot, the budget of producing the film, the release date of the film, the marketing strategy for the film and other similar films that are in the marketplace.

Social media systems are generally designed to be highly accessible web-based systems that can be configured to dynamically deliver or serve user-generated content, such as user profiles and user postings, to client systems. Such conventional social media systems provide for the creation and exchange of user-generated content. Currently, social media systems comprise a plurality of individual user accounts for the purpose of publishing user content. Accordingly, such conventional social media systems provide a publishing and delivery platform for individual users to publish and broadcast their user content to numerous recipients. Social media systems therefore offer an intriguing source of raw historical data to analyze past successes and failures of entertainment projects.

An artificial intelligence (AI) system is a computer system that implements human-level intelligence, and allows a machine to learn by itself, make a decision, and become smart unlike an existing rule-based smart system. As the AI system is used, the AI system has an improved recognition rate and accurately understands user's preferences. Machine learning is an algorithm technique that classifies/learns characteristics of input data by itself, and an element technology is a technology that simulates a function such as recognition, decision, etc., of a human brain by using a machine-learning algorithm such as deep learning, and includes technical fields such as linguistic understanding, visual understanding, inference/prediction, knowledge representation, operation control, and so forth.

AI technologies employ various fields. For example, linguistic understanding is a technique that recognizes, and applies/processes human languages/texts, and includes natural language processing, machine interpretation, a conversation system, question and answer, voice recognition/synthesis, and so forth. Visual understanding is a technique that recognizes and processes an object in the same manner as a human visual system, and includes object recognition, object tracking, image search, people recognition, scene understanding, space understanding, image enhancement, etc. Inference/prediction is a technique that determines information and performs logical inference and prediction, and includes knowledge/probability-based inference, optimization prediction, preference-based planning/recommendation, and so forth. Knowledge representation is a technique that automatizes human experience information as knowledge data, and includes knowledge establishment (data creation/classification), knowledge management (data utilization), and the like.

There is a need for an AI system that can predict performance of an entertainment product. Further, there exists a need for a deep learning technique for effectively predicting financial performance and public reception of an entertainment product or project.

### SUMMARY

According to some embodiments, there is a system for analyzing media asset data. The system includes a memory storing a media asset data, including media expectation data, media performance data, a user input device for receiving user input of a media characteristic, a processor configured to generate a media performance prediction from the media expectation data, the media performance data, and the media characteristic, and a display for displaying the media performance prediction.

The media performance prediction includes media asset data plotted against the media expectation data and media performance data.

The media performance prediction includes a performance prediction line bisecting the media asset data that has overperformed and underperformed.

The user input is further configured to receive a selection of at least one media asset data point, and wherein the display displays a media title for the at least one media asset data point.

The user input is further configured to receive a selection of a second media characteristic, and wherein the display displays a a performance success prediction indicator.

The memory further includes media consumption data, wherein the processor is configured to generate a media consumption prediction from the media consumption data and the media performance prediction, and wherein the display displays the media consumption prediction plot.

The media consumption prediction includes an enthusiasm index indicator.

The media consumption prediction includes a market share indicator.

The media consumption prediction includes a consumer geography, and wherein the media consumption plot includes a map.

The media consumption prediction includes a consumer demographic, and wherein the media consumption plot includes a bar graph or a market asset list.

According to some embodiments, there is a method of analyzing media asset data. The method includes receiving media asset data, including media expectation data, media performance data, receiving user input of a media characteristic, generating a media performance prediction from the media expectation data, the media performance data, and the media characteristic, and displaying the media performance prediction.

The method further includes receiving user input, selecting at least one media asset data point, and displaying a media title for the at least one media asset data point.

The method further includes receiving user input, selecting a second media characteristic, and displaying a performance success prediction indicator.

The method further includes receiving media consumption data, generating a media consumption prediction from the media consumption data and the media performance prediction, and displaying the media consumption prediction plot.

According to some embodiments, there is a computing device for predicting an outcome for an entertainment product. The computing device includes a processor, and a non-transitory computer-readable medium comprising code, executable by the processor, to cause the computing device to receive at least one characteristic of an entertainment product, analyze AI rules, which were set, learned, or trained before, analyze historical data from a historical database, apply the AI rules in a prediction model, and apply the at least one characteristic in the prediction model to predict the outcome for the entertainment product.

The entertainment product is a data based product.

The entertainment product is one of: a movie, a television show, a video, an online video, and a game, a televised sports event, a television event, a wildlife programme, a reality show, a drama show, a soap opera, a sketch show, a sitcom, a documentary, a docudrama, a series, a serial, a thriller, a detective series, a game show, a quiz show, a current affairs programme, a news show, a competition television series and a singing competition television series.

The at least one characteristic comprises one of: a scene type, a genre, an actor, an actor importance, a director, a plot attribute, a plot importance, a release year, marketing expenditures, a box office revenue and a market focus.

The outcome comprises one of: a projected box office revenue; an audience forecast; a distribution forecast; a campaign forecast; a reception forecast; and an enthusiasm forecast.

According to some embodiments, there is a method for predicting an outcome for an entertainment product. The method includes receiving at least one characteristic of an entertainment product, analyzing AI rules, which were set, learned, or trained before, analyzing historical data from a historical database, applying the AI rules in a prediction model, and applying the at least one characteristic in the prediction model to predict the outcome for the entertainment product.

According to some embodiments, there is a computing device for predicting an outcome for an entertainment product. The computing device includes a processor, and a non-transitory computer-readable medium comprising code, executable by the processor, to cause the computing device to select a frame from among a plurality of frames in the video, generate metadata associated with the selected frame, and determine a scene type associated with the selected frame based on the generate characteristics/metadata.

The processor causing the computer device to determine whether a preceding frame that precedes the selected frame and/or a following frame that follows the selected frame belong to the scene type.

The processor causing the computer device to generate audio metadata associated with audio of the selected frame or scene type.

The metadata associated with the selected frame includes object/tool, condition of a character, sound cues.

The processor causing the computer device to identify at least one character associated with the scene type.

The processor causing the computer device to determine the number of times the at least one character appears in the video.

The processor causing the computer device to identify a plurality of scenes, wherein each scene comprises neighbor frames that precede or follow the selected frame in the video, and determine a plot attribute associated with the plurality of scenes based on the metadata and/or audio metadata.

The plot attribute comprises one of action, explosion, murder, violence, pistol, death, shot in the chest, thriller, shot to death, shootout, machine gun, blood, martial arts, flashback, falling from height, chase, fistfight, hand to hand combat, adventure, punched in the face, held at gunpoint, bare chested male, rescue, knife, brawl, fight, shot in the head, shot in the back and revenge.

The processor causing the computer device to determine at least a genre on the plot attribute.

The genre comprises one of action, adventure, animation, biography, comedy, crime, documentary, drama, family, fantasy, history, horror, music, musical, history, romance, sci-fi, sport, thriller, war and western.

The processor causing the computer device to collect performance measurements associated with the plot attribute.

The processor causing the computer device to collect performance measurements associated with the plot attribute on marketing channels, wherein the marketing channels comprise at least one of: websites, mobile applications, venues, television and print.

The performance measurements comprise at least one of number of clicks, number of views, number of likes, number of shares, number of comments, number of visits, number of tweets, (positive and/or negative) feedbacks, comments, web site usage data, marketing campaign cost, production cost, advertising cost, box office revenue, and ROI.

The performance measurements are collected over a predetermined period of time.

According to some embodiments, there is a method for determining a plot attribute of a video/movie. The method includes selecting a frame from among a plurality of frames in the video, generating metadata associated with the selected frame, and determining a scene type associated with the selected frame based on the generated characteristics/metadata.

The method further includes determining whether a preceding frame that precedes the selected frame and/or a following frame that follows the selected frame belong to the scene type.

The method further includes generating audio metadata associated with audio of the selected frame or scene type.

The metadata associated with the selected frame includes object/tool (for example, identification of a gun), condition of a character (for example, blood on face, blood on head), sound cues (for example, explosion, music, etc.).

The method further includes identifying at least one character (for example, an actor/actress) associated with the scene type.

The method further includes determining the number of times the at least one character appears in the video.

The method further includes identifying a plurality of scenes, wherein each scene comprises neighbor frames that precede or follow the selected frame in the video, and determining a plot attribute associated with the plurality of scenes based on the metadata and/or audio metadata.

The plot attribute comprises one of action, explosion, murder, violence, pistol, death, shot in the chest, thriller, shot to death, shootout, machine gun, blood, martial arts, flashback, falling from height, chase, fistfight, hand to hand combat, adventure, punched in the face, held at gunpoint, bare chested male, rescue, knife, brawl, fight, shot in the head, shot in the back and revenge.

The method further includes determining at least a genre on the plot attribute.

The genre includes action, adventure, animation, biography, comedy, crime, documentary, drama, family, fantasy, history, horror, music, musical, history, romance, sci-fi, sport, thriller, war and western.

The method further includes collecting performance measurements associated with the plot attribute on marketing channels.

The marketing channels include websites (such as social media websites, video sharing websites, Facebook, Youtube etc.), mobile applications (such as Instagram, Facebook App, etc.), venues (such as movie theaters, etc.), television and print.

The performance measurements include number of clicks, number of views, number of likes, number of shares, number of comments, number of visits, number of tweets, (positive and/or negative) feedbacks, comments, web site usage data, marketing campaign cost, production cost, advertising cost, box office revenue, and ROI.

The performance measurements are collected over a predetermined period.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 illustrates a block diagram of a system for analyzing media asset data, according to one example.

FIG. 2 shows a block diagram of a device, according to one example

FIG. 3 shows a system diagram of the system, according to one example.

FIG. 4 shows a graphical interface of a system for predicting an outcome for an entertainment product, according to one example.

FIG. 5 shows a graphical interface of a system for predicting an outcome for an entertainment product, according to one example.

FIG. 6 shows a revenue diagram for entertainment product, according to one example.

FIG. 7 shows a map of demographics for entertainment product according to one example.

FIG. 8 shows a graph of characteristics of the demographics for the entertainment product, according to one example.

FIG. 9 shows a graph of occupations of the demographics for the entertainment product, according to one example.

FIG. 10 shows a graph of household incomes of the demographics for the entertainment product, according to one example.

FIG. 11 shows a graph of household incomes of the demographics for the entertainment product, according to one example.

FIG. 12 shows a graph of people followed by the demographics for the entertainment product, according to one example.

FIG. 13 shows a graph of people followed by the demographics for the entertainment product, according to one example.

FIG. 14 shows a graph of brands followed by the demographics for the entertainment product, according to one example.

FIG. 15 shows a graph of entertainment consumed by the demographics for the entertainment product, according to one example.

FIG. 16 shows a graph of interests of the demographics for the entertainment product, according to one example.

FIG. 17 shows an entertainment system, according to one example.

FIG. 18 shows a diagram of a prediction engine, according to one example.

FIG. 19 shows a method for predicting an outcome for an entertainment product, according to one example.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

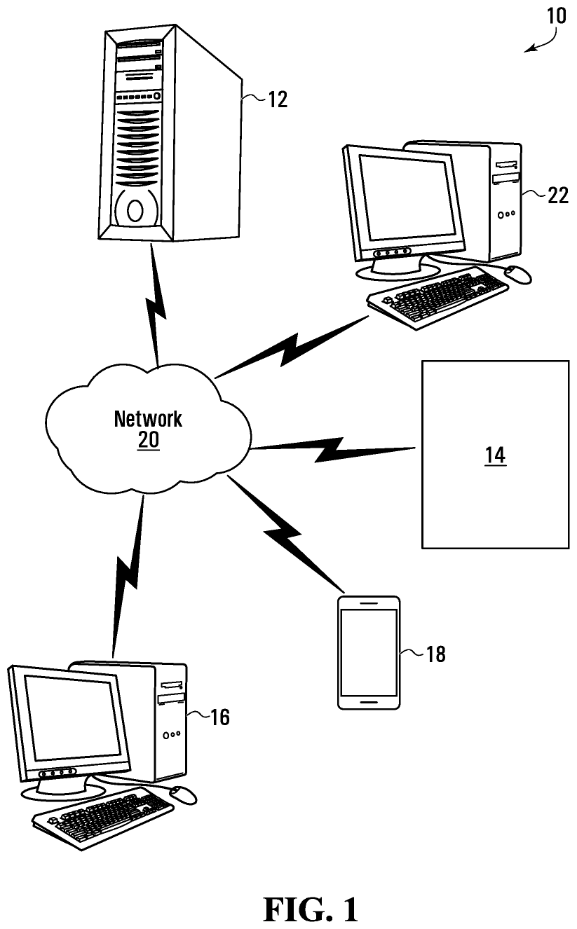

FIG. 1 shows a block diagram illustrating a system 10, in accordance with an embodiment. The system 10 includes a server platform 12, which communicates with a plurality of user devices 16, 18 and 22. The system 10 also includes a social media server platform 14, which can communicate with a plurality of social media platforms.

The server platforms 12 and 14, and devices 16, 18 and 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20.

Input device may include any device for entering information into device 12, 14, 16, 18, 22. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

Devices such as server platforms 12 and 14 and devices 16, 18 and 22 can be described performing certain acts. It will be appreciated that any one or more of these devices may perform an act automatically or in response to an interaction by a user of that device. That is, the user of the device may manipulate one or more input devices (e.g. a touchscreen, a mouse, or a button) causing the device to perform the described act. In many cases, this aspect may not be described below, but it will be understood.

As an example, it is described below that the devices 12, 14, 16, 18, 22 may send information to the server platforms 12 and 14. For example, a user using the device 18 may manipulate one or more inputs (e.g. a mouse and a keyboard) to interact with a user interface displayed on a display of the device 18. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the plurality of devices 16, 18, 22 and the server 14.

In response to receiving information, the server platform 12 may store the information in storage database. The storage may correspond with secondary storage of the devices 16, 18 and 22 and the server 14. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

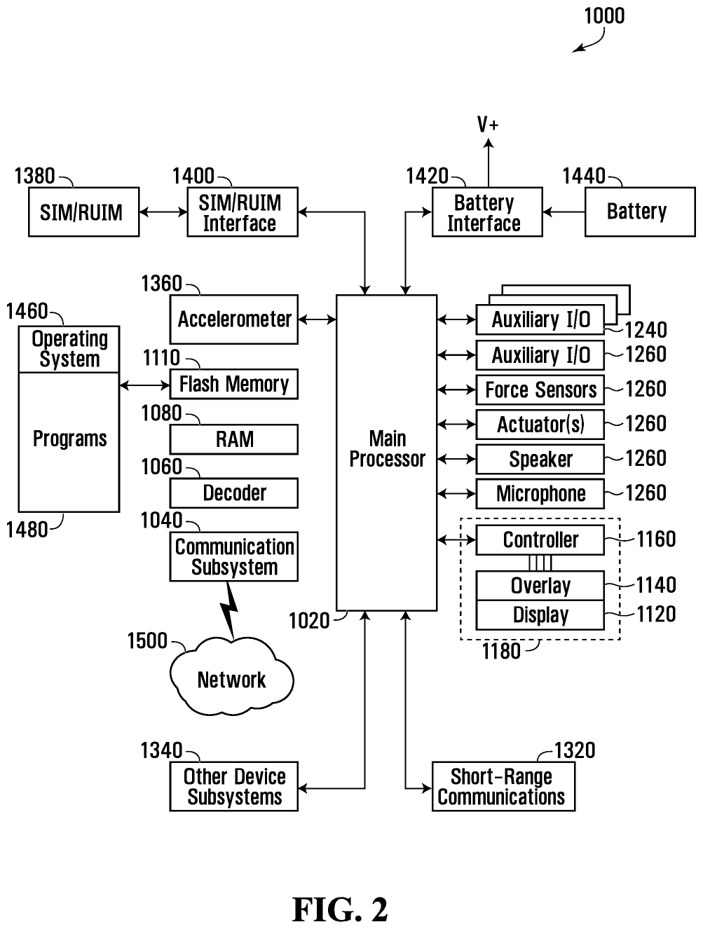

FIG. 2 shows a simplified block diagram of components of a device 1000, such as a mobile device or portable electronic device. The device 1000 includes multiple components such as a processor 1020 that controls the operations of the device 1000. Communication functions, including data communications, voice communications, or both may be performed through a communication subsystem 1040. Data received by the device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The device 1000 also includes an operating system 1460 and software components 1480 that are executed by the processor 1020 and which may be stored in a persistent data storage device such as the flash memory 1100. Additional applications may be loaded onto the device 1000 through the wireless network 1500, the auxiliary I/O subsystem 1240, the data port 1260, the short-range communications subsystem 1320, or any other suitable device subsystem 1340.

For example, in use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

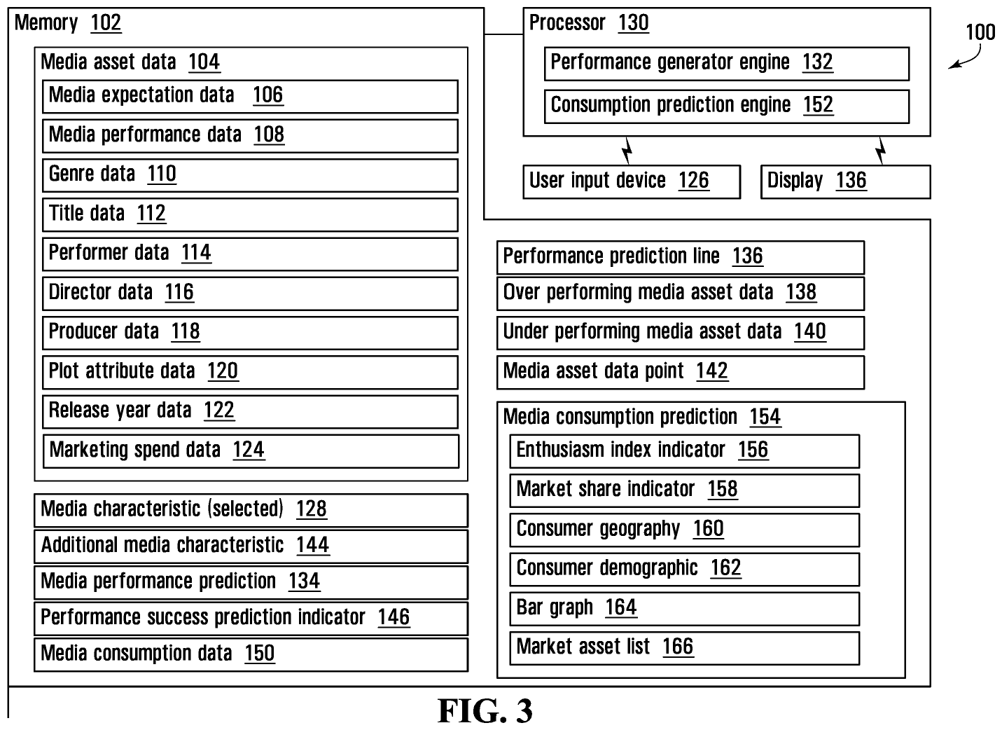

Referring now to FIG. 3, illustrated therein is a system 100 for analyzing media asset data, in accordance with an embodiment. The system 100 includes a memory 102 for storing media asset data 104. The memory 102 may be stored at a server (e.g., server 12 of FIG. 1) or at a user device (e.g., device 16, 18, of FIG. 1).

The media asset data 104 includes media expectation data 106 and media performance data 108. The media expectation data 106 may include the budget of the media asset. The media performance data 108 may include the box office receipts for the media asset.

The media asset data 104 includes data for any one or more of the genre 110 of the media asset, the title 112 of the media asset, the performers 114 in the media asset, the directors 116 and producers 118 of the media asset, plot attributes 120 of the media asset, the release year 122 of the media asset, and the marketing spend 124 of the media asset.

The media asset 104 may be an entertainment product and can be a data based product. For example, the entertainment product can be encoded in video data and/or audio data.

The entertainment product can be a movie, a television show, an online video, a video game, a television event, a televised sports event, a wildlife programme and a reality show. The entertainment product can also be a drama show, a soap opera, a sketch show, a sitcom, a documentary, a docudrama, a series, a serial, a thriller, a detective series, a game show, a quiz show, a current affairs programme, a news show, a competition television series and a singing competition television series.

The system 100 includes a user input device 126 for receiving user input of a media characteristic 128. The user input device 126 may be located at a user device (e.g. user device 18 of FIG. 1). The selection of the media characteristic 128 may be stored on the memory 102.

The system 100 includes a processor 130 including a performance generator engine 132. The performance generator engine 132 is configured to generate a media performance prediction 134 from the media expectation data 106, the media performance data 108, and the media characteristic 128. The performance generator engine 132 may use machine learning and artificial intelligence to generate the media performance prediction 134.

The processor 130 may be located at the server (e.g., server 12 of FIG. 1) or at the user device (e.g., device 16, 18, of FIG. 1).

The system 100 includes a display 136 for displaying the media performance prediction 134. The display may be at the user device (e.g., device 16, 18, of FIG. 1).

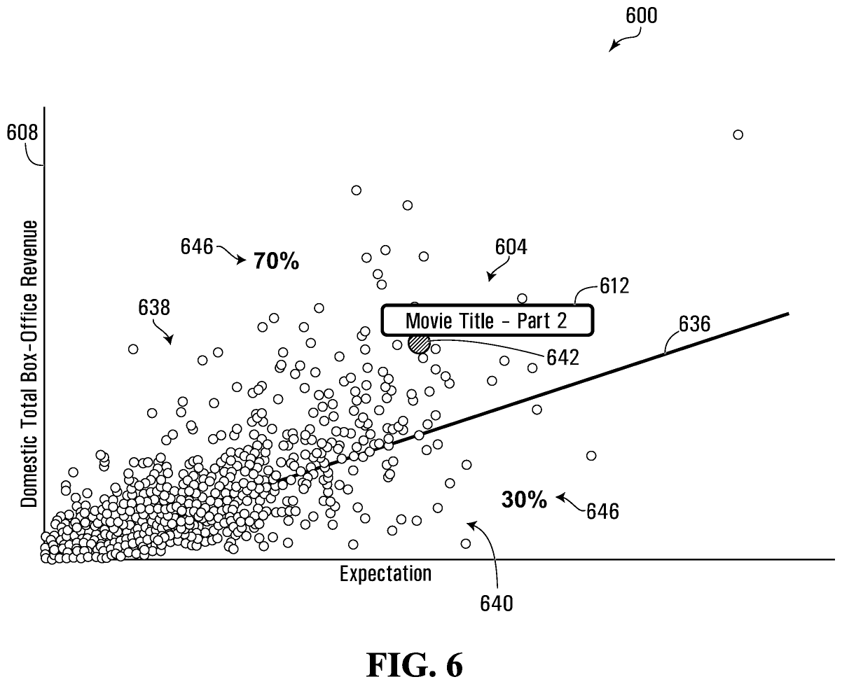

The media performance prediction 134 includes the media asset data 104 plotted against the media expectation data 106 and media performance data 108. An example media performance prediction 134 is shown at FIG. 6.

The media performance prediction 134 includes a performance prediction line 136 bisecting overperforming media asset data 138 and underperforming media asset data 140.

In an embodiment the media performance prediction 134 predicts the performance continuously. The processor 130 scores the media asset data 104 based on where the media asset data 104 is relative to the benchmark (for example, focus range at 422).

The media performance prediction 134 may be generated in real time.

The user input device 126 may receive, from a user, a selection of at least one media asset data point 142. To select, the user may hover over the media asset data point 142 or click on the media asset data point 142. The media asset data point 142 may be the selection of one particular media asset (e.g. film). The display 136 displays the title 112 for the at least one media asset data point 142.

The user input device 126 may receive, from a user, a second (or additional) media characteristic 144. The performance generator engine 132 generates an updated media performance prediction 134. The display 136 displays the updated media performance predication 134. The user selection of the additional media characteristic 144 may be a selection of a media asset data 104 such as the plot attribute 120 or performers 114.

The performance generator engine 132 may also generate a performance success prediction indicator 146 from the slope of the performance prediction line 136. The performance success prediction indicator 146 may be a percentage of the overperforming media asset data 138 and/or a percentage of the underperforming media asset data 140.

The memory 102 includes media consumption data 150. The media consumption data 150 may relate to information about the consumers of the media asset (for example, a viewer of a film). The processor 130 includes a consumption prediction engine 152. The consumption prediction engine 152 is configured to generate a media consumption prediction 154 from the media consumption data 150 and the media performance prediction 134. The consumption prediction engine 152 may use machine learning and artificial intelligence to generate the media consumption prediction 154.

The media consumption prediction 154 is stored in the memory 102. The display 136 displays a plot of the media consumption prediction 154.

The media consumption prediction 154 includes an enthusiasm index indicator 156. The enthusiasm index indicator 156 indicates the level of interest of a particular subset of the consumers in the selected media asset data 104. The enthusiasm index indicator 156 may be displayed on the display 136 as differing shades. A darker shade indicates a higher level of interest and a lighter shade indicates a lower level of interest.

The media consumption prediction 134 includes a market share indicator 158. The market share indicator 158 indicates the size of the market associated with a particular subset of the consumers for the selected media asset data 104. The market share indicator 158 may be displayed on the display 136 in differing sizes. A larger market share indicator 158 indicates a higher market share and a smaller market share indicator 158 indicates a lower market share.

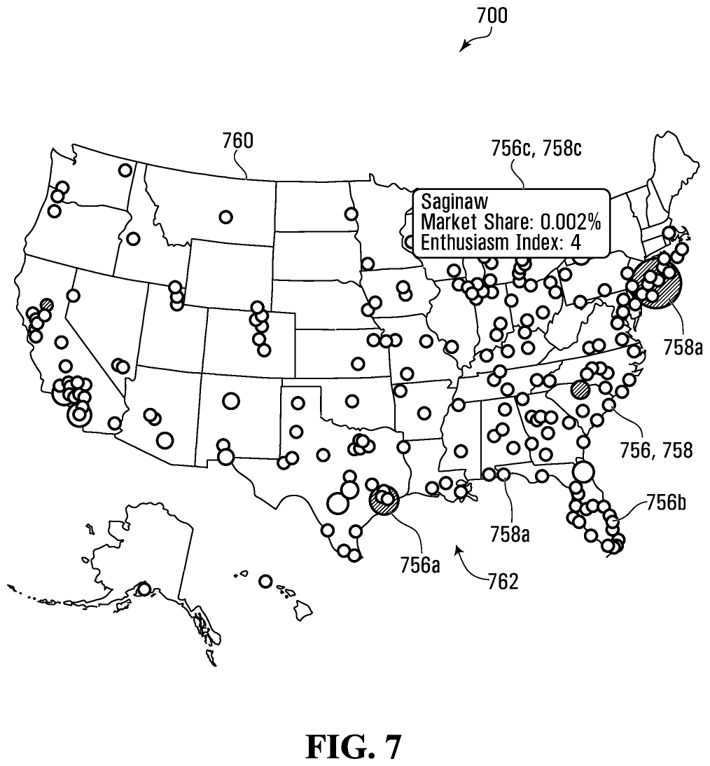

The media consumption prediction 134 includes a consumer geography 160. The consumer geography 160 is associated with the location of a particular subset of the consumers for the selected media asset data 104. The plot of the media consumption 134 includes a media consumption map 162 (e.g., as illustrated at FIG. 7).

The media consumption map 162 may be displayed on the display 136 and include the enthusiasm index indicator 156 and the market share indicator 158. The enthusiasm index indicator 156 and the market share indicator 158 may be displayed after user selection by the user input device 126 (for example hovering over a particular location on the media consumption map 162).

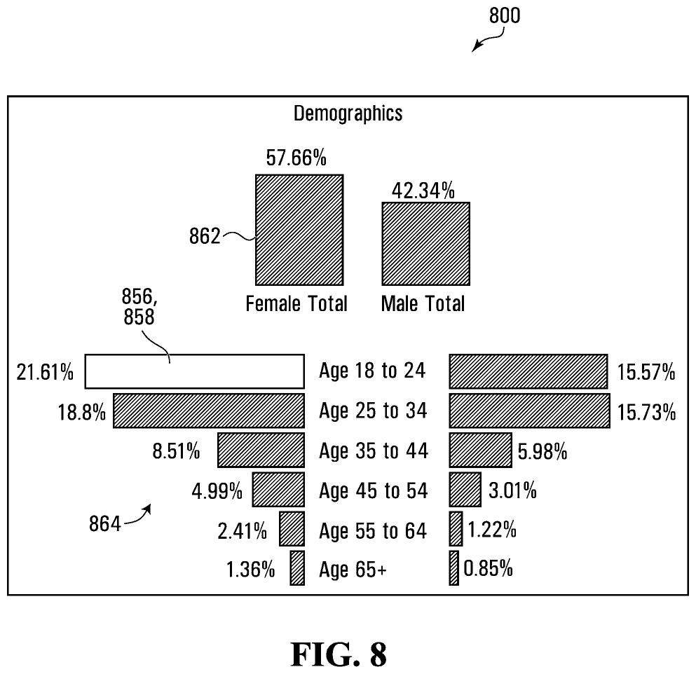

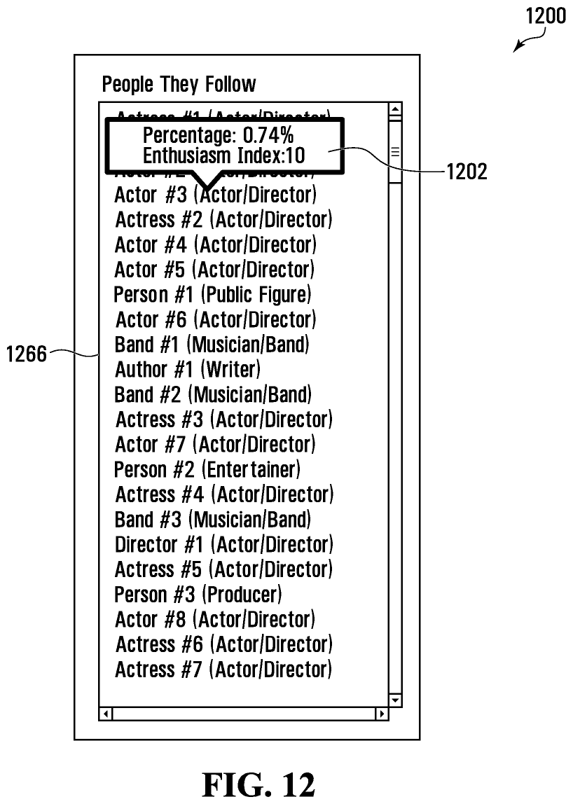

The media consumption prediction 134 includes a consumer demographic 162. The consumer demographic 162 is associated with the personal attributes of a particular subset of the consumers for the selected media asset data 104. The plot of the media consumption 134 includes a bar graph 164 (e.g., as illustrated at FIGS. 8 to 11). The plot of the media consumption 134 includes a market asset list 166 (e.g., as illustrated at FIGS. 12 to 16).

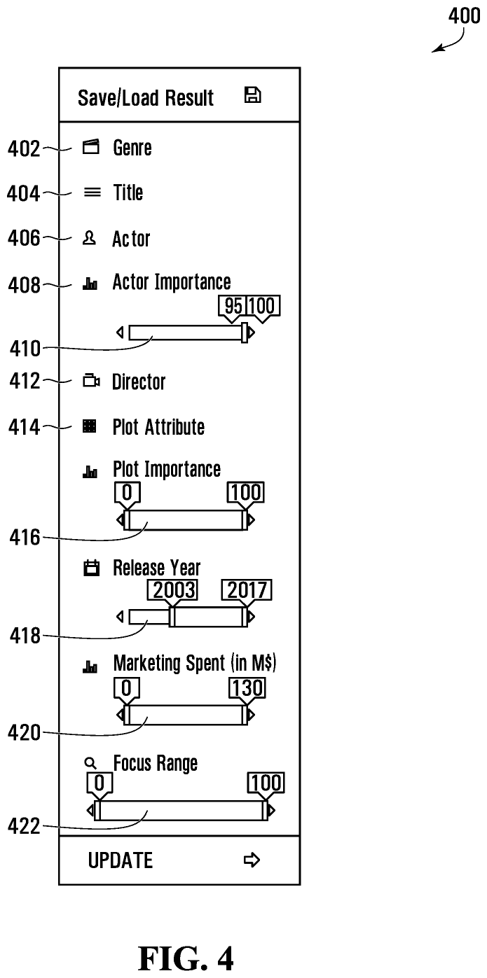

Referring to FIG. 4, there is shown a graphical interface 400 in accordance with an embodiment of the system 100. The graphical interface 400 can be used to enter and/or receive media asset data 104. At 402, a user can select and/or enter a genre for the entertainment product. For example, the genre can be: action, adventure, animation, biography, comedy, crime, documentary, drama, family, fantasy, history, horror, music, musical, history, romance, sci-fi, sport, thriller, war and/or western, etc.

At 404, a user can select and/or enter a title for the entertainment product. Examples of titles can be but are not limited to: Star Wars, Raiders of the Lost Island, Fly High, Heat, etc.

At 406, the user can select and/or enter an actor for the entertainment product. Examples of actors can be but are not limited to: Jennifer Lawrence, Julia Roberts, Meryl Streep, Dwayne Johnson, Will Smith, Johnny Depp, etc.

At 408 and 410, the user can select and/or enter an actor importance characteristic for the entertainment product. For example, the actor importance can be determined by the amount of time the actors appears in the entertainment product. For example, the actor importance can be determined by how important the actor is to the main plot. For example, the actor importance can be measured on a scale of 0% to 100%.

At 412, the user can select and/or enter a director for the entertainment product. Examples of directors can be but are not limited to: Steven Spielberg, Martin Scorsese, Quentin Tarantino, etc.

At 414, the user can select and/or enter a plot attribute for the entertainment product. Examples of plot attributes can be but are not limited to: action, explosion, murder, violence, pistol, death, shot in the chest, thriller, shot to death, shootout, machine gun, blood, martial arts, flashback, falling from height, chase, fistfight, hand to hand combat, adventure, punched in the face, held at gunpoint, bare chested male, rescue, knife, brawl, fight, shot in the head, shot in the back, revenge, etc.

At 416, the user can select and/or enter a plot importance for the entertainment product. For example, the plot importance can be measured on a scale of 0% to 100%.

At 418, the user can select and/or enter a release year. At 420, the user can select and/or enter marketing expenditures. At 422, the user can select and/or enter a market focus for the entertainment product.

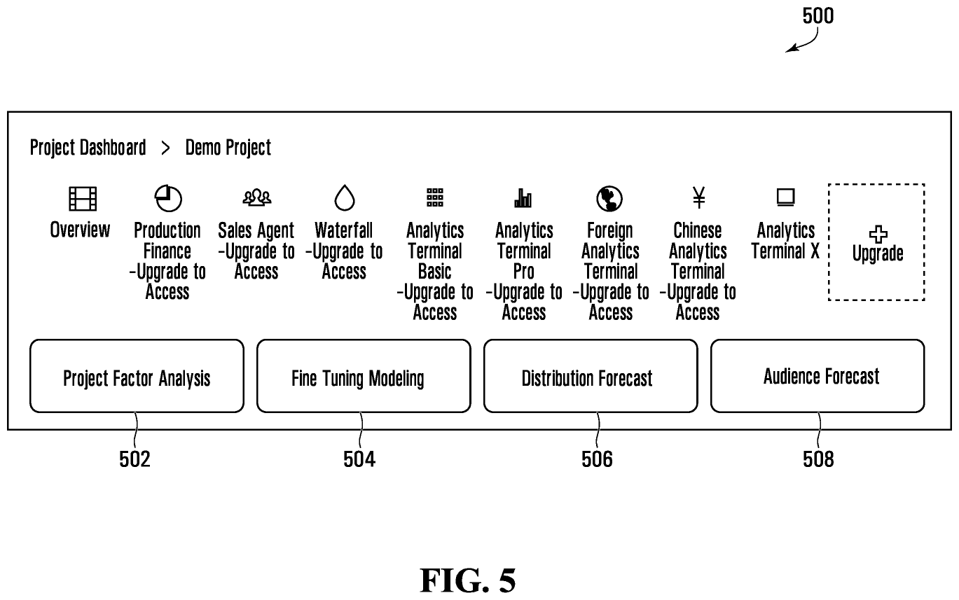

Referring to FIG. 5, a graphical interface 500 in accordance with an embodiment of the system 100 is shown therein. The graphical user interface 500 provides access to project factor analysis 502 and fine-tune model 504 for the entertainment product. In addition, the graphical user interface 500 provides access to a distribution forecast 506 and an audience forecast 508 for the entertainment product. The system can be configured to analyze AI rules which were set, learned, or trained before. The system can be configured to analyze historical data from a historical database. The system can be configured to apply the AI rules in a prediction model.

The system may also be configured to apply characteristics in the prediction model to predict an outcome for the entertainment product. For example, the system can predict a projected box office revenue for the entertainment product. The system can also predict an audience forecast, a distribution forecast, a campaign forecast, a reception forecast, and an enthusiasm forecast for the entertainment product.

Referring to FIG. 6, there is shown a graphical interface of a media performance prediction 600 in accordance with an embodiment. The media performance prediction 600 includes media asset data 604 plotted against the media expectation data 606 and media performance data 608.

The media performance prediction 600 includes a performance prediction line 636 bisecting overperforming media asset data 638 and underperforming media asset data 640. The user input device 126 may receive, from a user, a selection of at least one media asset data point 642. To select, the user may hover over the media asset data point 642 or click on the media asset data point 642. The media asset data point 642 may be the selection of one particular media asset (e.g. film). The display 136 displays the title 612 for the at least one media asset data point 642.

The performance generator engine 132 may also generate a performance success prediction indicator 646 from the slope of the performance prediction line 136. The performance success prediction indicator 646 may be a percentage of the overperforming media asset data 638 and/or a percentage of the underperforming media asset data 640.

Referring to FIG. 7, there is media consumption prediction 700, in accordance with an embodiment. For example, the media consumption prediction 700 can a data structure map, showing various traits of the demographics targeted by the entertainment product characteristics. The demographic map can include locations indicating where the target market for the entertainment product is located.

The media consumption prediction 700 includes an enthusiasm index indicator 756. The enthusiasm index indicator 756 indicates the level of interest of a particular subset of the consumers in the selected media asset data 104. The enthusiasm index indicator 756 may be displayed on the display 136 as differing shades. A darker shade (756a) indicates a higher level of interest and a lighter shade (756b) indicates a lower level of interest.

The media consumption prediction 700 includes a market share indicator 758. The market share indicator 758 indicates the size of the market associated with a particular subset of the consumers for the selected media asset data 104. The market share indicator 758 may be displayed on the display 136 in differing sizes. A larger market share indicator 758a indicates a higher market share and a smaller market share indicator 758b indicates a lower market share.

The media consumption prediction 134 includes a consumer geography 760. The consumer geography 760 is associated with the location of a particular subset of the consumers for the selected media asset data 104. The plot of the media consumption 734 includes a media consumption map 762.

A detailed enthusiasm index indicator 756c and a detailed market share indicator 758c may be displayed after user selection by the user input device 126 (for example hovering over a particular location on the media consumption map 762). The detailed enthusiasm index indicator 756c may include a number value of how enthusiastic the market is. The detailed market share indicator 758c may include the percent of the national market. The name of the market may be included with the indicators 756c, 758c.

Referring to FIG. 8, there is shown a media consumption prediction 800 showing characteristics of the demographics for the entertainment product characteristics selected in FIG. 4. The media consumption prediction 800 includes at least one consumer demographic 862. The consumer demographic 862 is associated with the personal attributes (gender and age) of a particular subset of the consumers for the selected media asset data 104. The plot of the media consumption 800 includes a bar graph 864. The media consumption prediction 800 includes an enthusiasm index indicator 856 (darker indicates more relative enthusiasm, lighter indicates lower relative enthusiasm) and a market share indicator 858 (larger size indicates larger percentage of market, smaller size indicates smaller percentage of market). As shown in FIG. 8, the enthusiasm index indicator 856 and market share indicator 858 may be integrated.

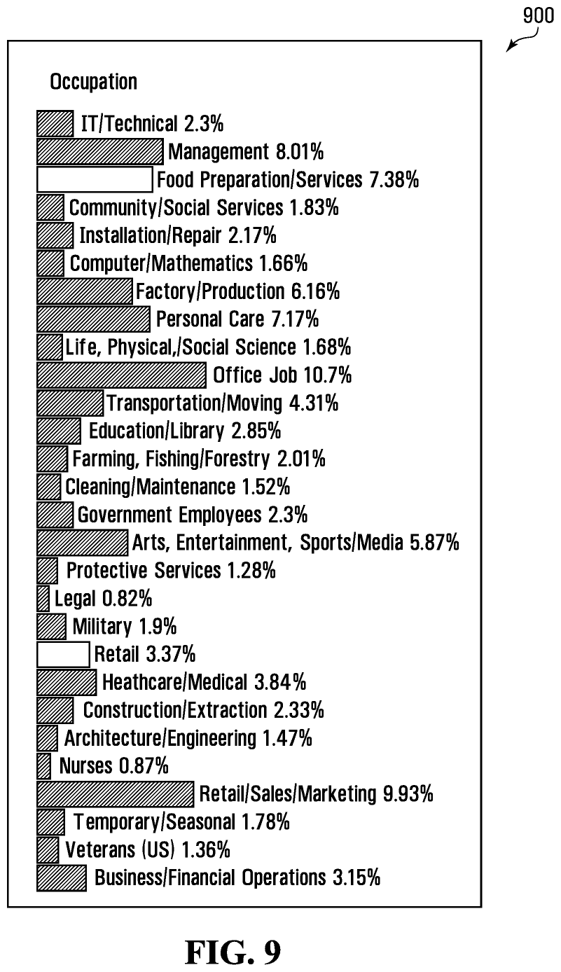

Referring to FIG. 9, there is shown a media consumption prediction 900 showing occupations of the demographics for the entertainment product characteristics selected in FIG. 4. For example, 2.3% of the demographics work in IT/technical field and 8.01% of the demographics work in management, etc. As in FIG. 8, the media consumption prediction 900 includes enthusiasm index indicators and market share indicators.

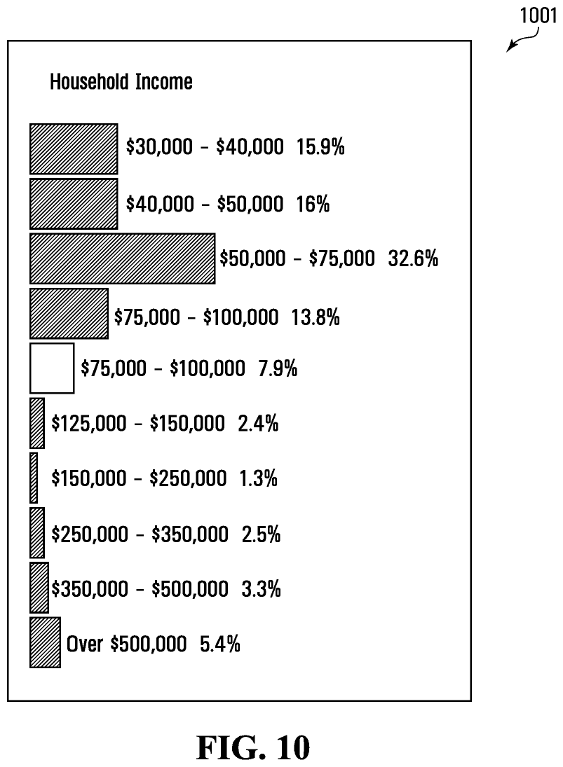

Referring to FIG. 10, there is shown a media consumption prediction 1001 showing household incomes of the demographics for the entertainment product characteristics selected in FIG. 4. For example, 15.9% of the demographics make between $30 k and $40 k; and 16% of the demographics make between $40 k and $50 k, etc. As in FIG. 8, the media consumption prediction 1001 includes enthusiasm index indicators and market share indicators.

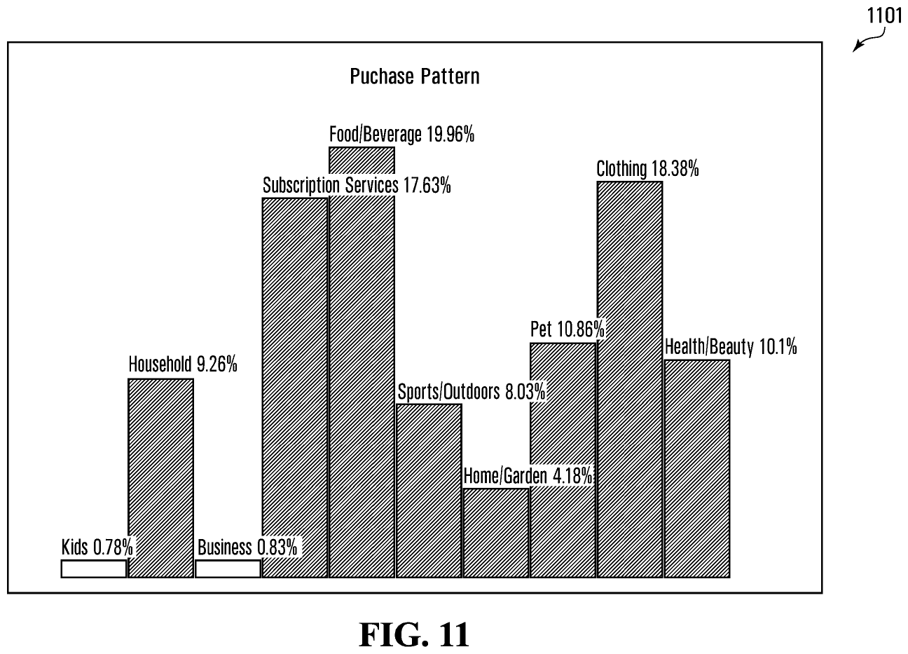

Referring to FIG. 11, there is shown a media consumption prediction 1101 showing purchase patterns of the demographics for the entertainment product characteristics selected in FIG. 4. For example, 17.63% of the demographics have a subscription service (such as Netflix) and 10.86% have a pet. As in FIG. 8, the media consumption prediction 1101 includes enthusiasm index indicators and market share indicators.

Referring to FIG. 12, there is shown a media consumption prediction 1200, in accordance with an embodiment. The media consumption prediction 1200 includes a market asset list 1266.

For example, the media consumption prediction lists people followed by the demographics for the entertainment product characteristics selected in FIG. 4. As shown, the demographics follow people like Taylor Lautner (Actor/Director), Batman (Public Figure), Stan Lee (Writer), etc.

The media consumption prediction 1200 includes a combined enthusiasm index and market share indicator 1202. The combined enthusiasm index and market share indicator 1202 is displayed when a user selects one from the list 1266. The combined enthusiasm index and market share indicator 1202 displays features of the selected person, such as Will Ferrell (Percentage: 0.74-Enthusiasm index: 10). Each entry on the list 1266 may also be displayed in a lighter or darker shade indicating the enthusiasm (lighter shade indicating less relative enthusiasm and darker shade indicating more relative enthusiasm).

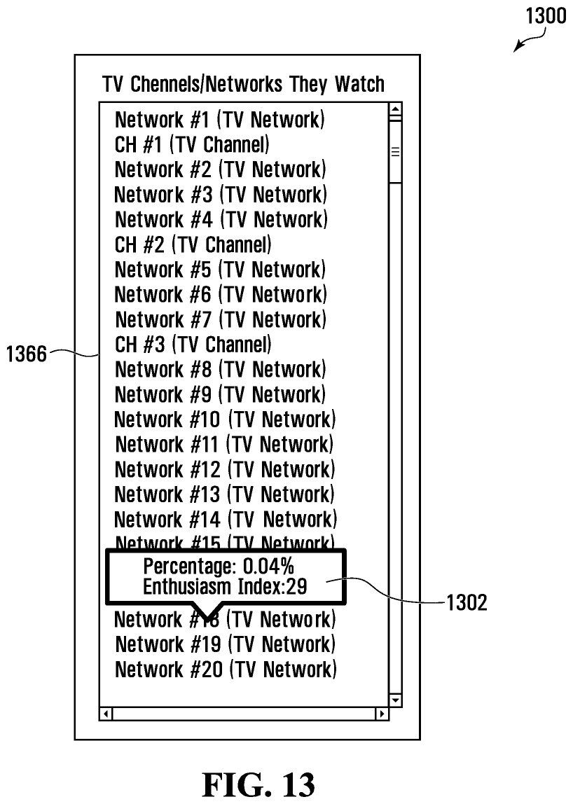

Referring to FIG. 13, there is shown the media consumption prediction 1300, in accordance with an embodiment. As similarly described with respect to FIG. 12, the media consumption prediction 1300 includes a list 1366 and a combined enthusiasm index and market share indicator 1302.

The media consumption prediction 1300 shows TV channels and networks watched by the demographics for the entertainment product characteristics selected in FIG. 4. The demographics watch channels and networks such as Freeform, Disney Channel Canada, Cartoon Network, etc. As shown at 1302, a user can hover a pointer over one of the TV channels and networks, which triggers a window to appear and display features of the network, such as HBO (Percentage: 0.04%-Enthusiasm index: 29).

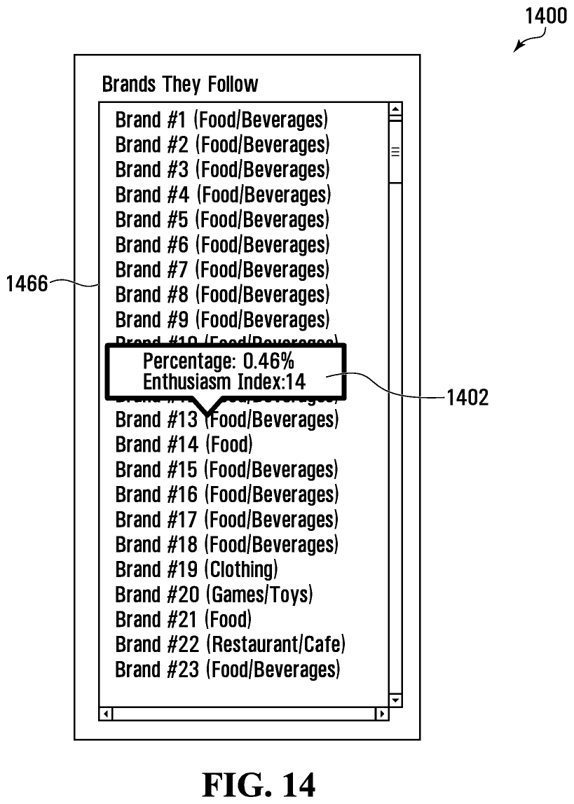

Referring to FIG. 14, there is shown a media consumption prediction 1400, in accordance with an embodiment. As similarly described with respect to FIG. 12, the media consumption prediction 1400 includes a list 1466 and a combined enthusiasm index and market share indicator 1402.

The media consumption prediction 1400 shows brands followed by the demographics for the entertainment product characteristics selected in FIG. 4. As shown, the demographics follow brands such as Sunkist Soda™, Skittles™, etc. As shown at 1402, a user can hover a pointer over one of the brands, which triggers a window to appear and display features of the brand, such as Kellogg's Pop-Tarts (Percentage: 0.46%-Enthusiasm index: 14).

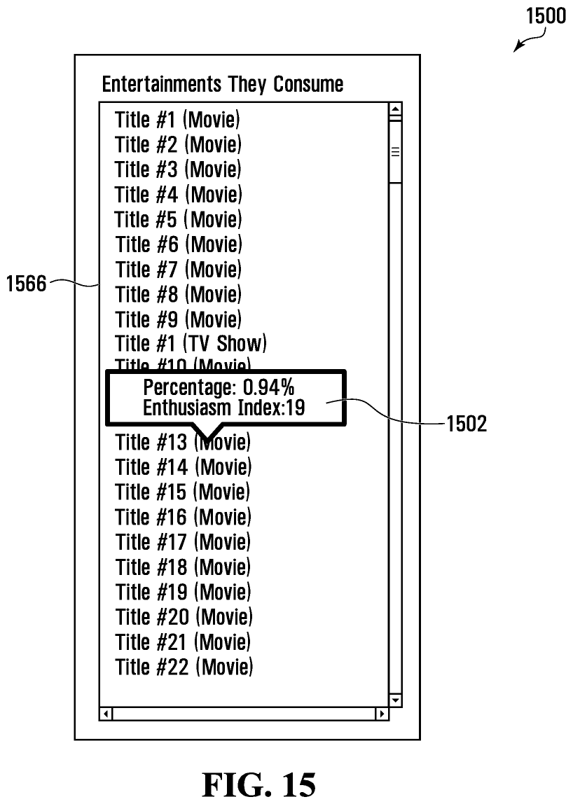

Referring to FIG. 15, there is shown a media consumption prediction 1500, in accordance with an embodiment. As similarly described with respect to FIG. 12, the media consumption prediction 1500 includes a list 1566 and a combined enthusiasm index and market share indicator 1502.

The media consumption prediction 1500 shows entertainment consumed by the demographics for the entertainment product characteristics selected in FIG. 4. As shown, the demographics consume entertainment such as Grown Up (movie), Big Momma's movies, etc. As shown at 1502, a user can hover a pointer over one of the brands, which triggers a window to appear and display features of the entertainment, such as Fast and Furious (Percentage: 0.94%-Enthusiasm index: 19).

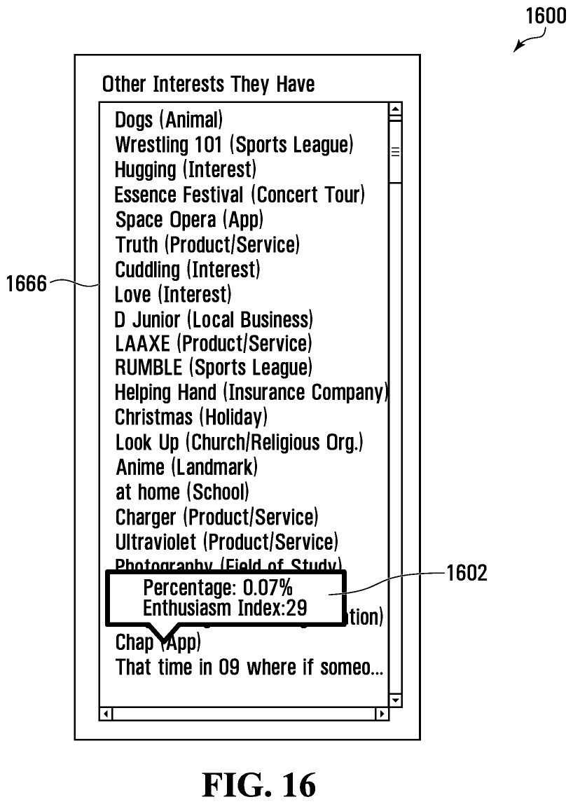

Referring to FIG. 16, there is shown a media consumption prediction 1600, in accordance with an embodiment. As similarly described with respect to FIG. 12, the media consumption prediction 1600 includes a list 1666 and a combined enthusiasm index and market share indicator 1602.

The media consumption prediction 1600 shows interests of the demographics for the entertainment product characteristics selected in FIG. 4. As shown, the demographics are interested in dogs, WWE, hugging, etc. As shown at 1602, a user can hover a pointer over one of the interests such that a window appears and displays features of the interest such as percentage (0.07%) and enthusiasm index (26).

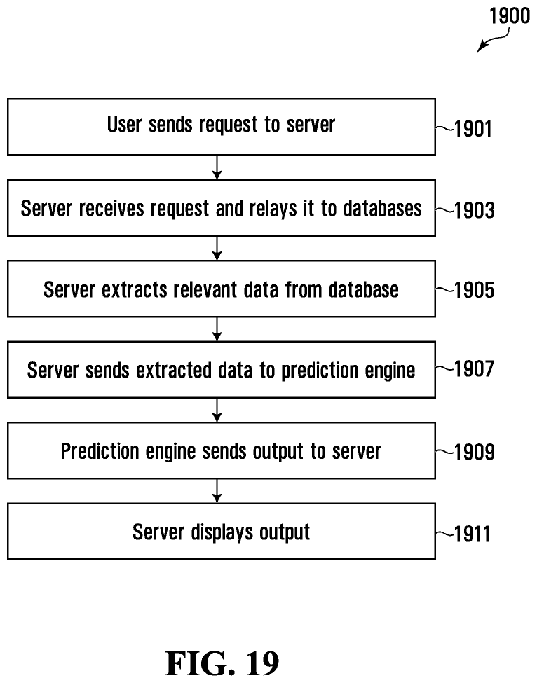

Referring to FIG. 19, there is shown a method 1900 for predicting an outcome for an entertainment product. At 1901, a user sends a request to the server. For example, a user can send a query to the server to predict an outcome for an entertainment product. An interface as shown in FIG. 4 can be presented to the user to enter variable regarding the entertainment product, such as genre, title, actor, plot attribute, etc.

At 1903, the server receives the request and go to the database to grab corresponding data. Upon receiving the request, the server can connect to one of the databases (as shown in FIG. 3) to grab the data points that fit in to the query. The, the server sends this data to the prediction engine for determining the outcome of the entertainment product.

At 1905, the server extracts the relevant database from the database. At 1907, the server send extracted data to the prediction engine and uses the prediction engine to generate benchmark or uses previously computed benchmark. The prediction engine calculates variation for each data points comparing to the benchmark by subtracting each data points' benchmark value from its performance measurement. The prediction engine also calculates the result statistic for each product formulation variable based on the remaining variation by correlating each product formulation variable to the remaining variation.

At 1909, the prediction engine sends outputs to the server. At 1911, the server outputs the results and benchmarks along with the data. The results can be displayed in graphical user interface.

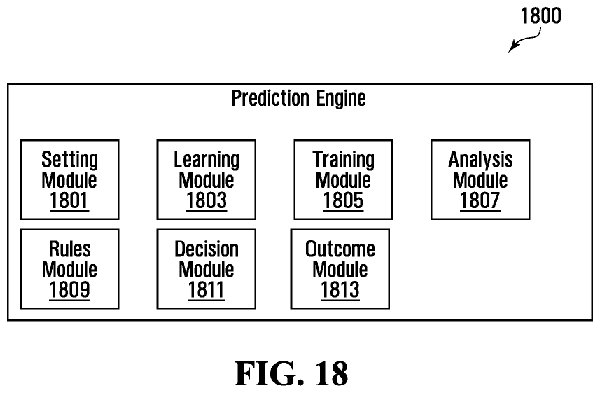

Referring to FIG. 18, there is shown a diagram of a prediction engine 1800. The prediction engine includes a setting module 1801, a learning module 1803, a training module 1805, an analysis module 1807, a rules module 1809, a decision module 1811, and an outcome module 1813.

The prediction engine includes a setting module that receives the data from server. The setting module can be used to format the data so that it can be processed by the other modules of the prediction engine. The setting module can be configured to receive a client request and additional inputs from the database. The setting module can be used to format data. The learning module can be configured to calculate indicators.

The learning module is designed to use data (from the different databases (for example, the social media database)) to extract informative insights for product formulation of entertainment products. For example, the insights can come from the social media database (which contains can contain commercial and word of mouth insights for different entertainment products, such as, but not limited to, movies, TV shows, online videos and games). The learning module can also learn correlations/relationships between certain variables (such as, but not limited to, marketing expenditures, performances, or seasonality) from performance measurements (such as, but not limited to, box office revenue or word of mouth rating).

The learning module can be configured to create benchmarks (i.e. point of reference) that illustrate the relationship between performance measurements and the variables selected by the user. The benchmark can be generated using statistical methods such as, but not limited to, regression, quantile regression, loss, quantile loss or machine learning algorithms such as neural networks, SVM, or boosting etc.

The training module can be configured to evaluate the statistical methods used by the learning module. The training module can test run the statistical methods on a subset of the data stored by the databases to select the best methods according to predefined parameters.

The analysis module receive the learned data from the learning module and analyze their effects. The analysis module can isolate the effects by creating a benchmark that represents the relationship between these certain variables and the performance measurements.

The analysis module can define the creative strength or commercial viability of an entertainment product as a comparative distance between each individual data points' performance measurement and a computed benchmark.

Defining Variations

After creating the benchmark, the analysis module can define variations as the distance between an individual data point's performance measurements to its. Such variations can include for example creative strength, commercial viability or other measurement of interest. These variations can be due to factors other than the isolated variables entered by the user. These variations are used to determine the correlation with desired product formulation variables that would assist in product formulation. This correlation calculation can be done in many ways such as, but not limited to, Multivariate Regression, Decision trees, Neural Networks, Boosting and the like. For instance, if quantile loss is used to generate a benchmark for data point A (an individual entertainment product, a movie or a game), the variation is calculated accordingly.

Undesired Variables for the Data Point

The analysis module looks up the value for the undesired variables of data point A, for example, assume this is the number of weeks after product release and equals 10 weeks.

Closest Data Points

Next, for simplicity, the analysis module picks the four closest data points to A based on the value of the undesired variable (number of weeks after product release). Say that these four data points are B, C, D, E with undesired variable value at 8, 9, 11 and 12.

Looking Up Performance Measurements

The analysis module then looks up the performance measurement (total sales of this product) for these five data points, A, B, C, D and E, assume that the performance measurements (total sales of this product) are $12,$11,$13,$14,$15, respectively. The analysis module sees the median is at $13, and assigns $13 as the benchmark when the undesired variable (number of weeks after product release) is at 10.

Calculating Remaining Variations

Next, the analysis module calculates the remaining variation for data point A by subtracting its benchmark value, $13, from its performance measurement, $12. In the end, data point A will be assigned a remaining variation of $−1.

In order to illustrate how to correlate the remaining variation to the product formulation variables, more than one data point can be 1 needed. Assume that the previous computation is performed for all five data points mentioned above, A, B, C, D and E, and also assume the remaining variation is found to be $−1,$2,$1,$−1, and $1, respectively {A:$−1, B:$2, C:$1, D:$−1, E:$1}.

What Product Formulation Variable the Data Points Contain

The analysis module then looks up what product formulation variable these five data points contain. Assume point A and D contain product formulation variable delta, lambda, and points B, C and E contain variable delta, sigma. For simplicity a simple percentage count method is used such that the prediction engine (math module) determines that lambda has two appearances both with negative remaining variation (only A,D contain lambda, and remaining variation are $−1 and $−1) in the five data points so lambda is assigned 0% over the benchmark as its result statistic.

Repeat Calculation

Repeat this calculation for delta and sigma, we end up with 60% (A, B, C, D and E contain delta, and three out of five have positive remaining variation) and 100% (only B, C and E contain sigma, and all of their remaining variation are positive) over the benchmark as their result statistic accordingly.

Assigning Desired Product Formulation Variable with Informative Statistical Results

Finally, each desired product formulation variable is assigned with one or more informative statistical results that reflect the effect of it on the performance measurement. This result can be generated by the rule module using any statistic or machine learning algorithm.

Filtering and Sorting

The decision module then filters and sorts this result by criteria (frequency or significance level). The server CPU finally outputs the desired variables with the calculated and sorted results which the server then sends, along with the data, to the client.

Client Receives the Information and Plotting Data Points

The client receives the outputs from the outcome module and uses the system's graphical user interface to plot the data points and benchmark along with the computed results in a 2D or 3D space with a list of desired variables.

In another embodiment, the Client sends data request to the server using a request module. On the client side, the client can send a data request to the server based on genre, desired variables, undesired variables and remaining variation using the CPU's request module. Then, upon receiving the data from the server, the CPU's visualization module creates a list of desired variables and a graphical representation of performance measurement and benchmark. This list of desired variables is interactive with the graphical representation. As the client selects each desired variable, the data points in the graphical representation will be highlighted, and as the client selects any data points in the graphical representation, the list of corresponding desired variable will also be highlighted.

### Example 1

(a) Sending a Query

As an exemplary embodiment, to analyze movies' box office revenue, a client first sends a query to the server indicating that it wishes to set the performance measurement as box office revenue in a specific genre of movies.

(b) Server Connects to Databases

The server connects to the database to filter out the data that is not needed. [Explain the different types of database]. The database treats each individual movie as an object and stores each movie with its title, box office revenue, marketing expenditures, and product formulation variables such as: talent and attributes.

(c) Prediction Engine Creates Benchmarks

Next, the prediction engine creates a benchmark using quantile loess to illustrate the relationship between marketing expenditures and box office revenue. Specifically, when quantile loess is used to generate this benchmark, for each different value of marketing spending, the prediction engine calculates the median box office revenue of movies whose marketing expenditures are almost the same. Then, the prediction engine generates a benchmark line by connecting these values across different values of marketing expenditures. Note that instead of using all the data to generate the benchmark, subsets of data with specific characteristics may also be used. For instance, a benchmark may be generated using Action movies only, and this benchmark will be specially good for analyzing Action movies.

(d) Regression and Machine Learning Algorithms

Again, quantile loess is not the only method that is contemplated and, other methods (regression and machine learning algorithms) mentioned in the above would require different operations from the prediction engine (math module). For instance, if we are using linear regression to compute the benchmark, assume Y is a matrix that contains box office revenue for every data points, Bm is a matrix that will be the benchmark for every data points and X is a matrix that contains marketing variables for every data points. The marketing variables include expenditures and variables that illustrate the marketing strategy for the underlying product. For example, the marketing variables may include data relating to how wide the release, who is doing the release, the time of the year of the release, and the year of the release.

The prediction engine (math module) will solve β in the equation Bm=Xβ. It will do so by calculating β=(XTX)−1XTY. Then the benchmark will be calculated and assigned by Bm=Xβ.

(e) Comparing Box Office Revenue to the Benchmark Line

By comparing box office revenue to the benchmark line, it is possible to get the remaining response variation (creative strength or commercial viability) that is more correlated to the talents (actors, directors) and attributes (plot, genre) of the movies (these are all product formulation variables).

(f) Comparing

The prediction engine can then rank movies by this remaining variation from highest to lowest, and make this rank a feature that the client can filter movies by. The client can also request to isolate multiple undesired variables, such as seasonality, the competition in the market place, or the combination of many.

(g) Computing Distance

After creating the benchmark, the distance between individual movie's box office revenue and its benchmark value can be computed. This distance, or the remaining variation of the box office revenue (creative strength or commercial viability), is now more correlated to the talent and attribute rather than the raw box office revenue.

(h) Computing Statistical Results

Then, the CPU calculates the statistical result of the talent and attribute. For simplicity, we can use the percentage of movies starring the talent, or containing the attribute, over the benchmark as the result statistic (binary).

Sorting and Filtering

The server then sorts and sends this result statistic along with the talent, or attribute, and data points to the client. The client plots data points with the benchmark in a 2D space whose vertical axis is box office revenue and horizontal axis is the expected performance of the media asset. The expected performance may be a function of the marketing expenditures and marketing variables. The client also receives the sorted list of talent and attribute with their computed results, so that the effect of each talent and attribute is visualized interactively with the data. The talent or the attribute with higher percentage over the benchmark will signal better effect to the performance measurement and the more below, the worse.

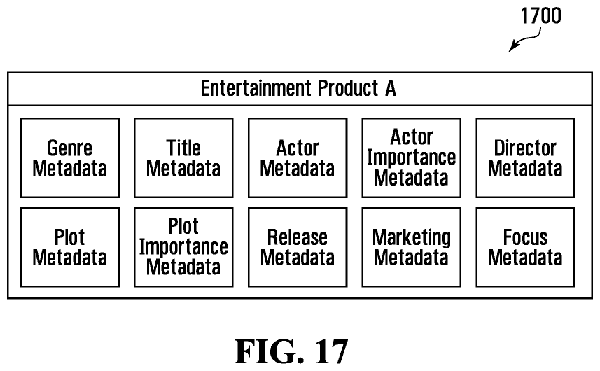

Referring to FIG. 17, there is disclosed media asset data 1700 comprising different types of metadata about a media asset or entertainment product. A computing device can be used to generate such metadata for an entertainment product. The entertainment product can be video-based. The computing device can select a frame from among a plurality of frames in the entertainment product video and generate metadata associated with the selected frame. As such, it can determine a scene type associated with the selected frame based on the generate characteristics/metadata.

The computing device can determine whether a preceding frame that precedes the selected frame and/or a following frame that follows the selected frame belong to a scene type. The computing device can generate audio metadata associated with audio of the selected frame or scene type.

The metadata associated with the selected frame can include object/tool (for example, identification of a gun), condition of a character (for example, blood on face, blood on head), sound cues (for example, explosion, music, etc.).

The computing device can identify at least one character (for example, an actor/actress) associated with the scene type. The computing device can determine the number of times the at least one character appears in the video.

The computing device can identify a plurality of scenes, wherein each scene comprises neighbor frames that precede or follow the selected frame in the video; and determine a plot attribute associated with the plurality of scenes based on the metadata and/or audio metadata. For example, the plot attribute can include one of: action, explosion, murder, violence, pistol, death, shot in the chest, thriller, shot to death, shootout, machine gun, blood, martial arts, flashback, falling from height, chase, fistfight, hand to hand combat, adventure, punched in the face, held at gunpoint, bare chested male, rescue, knife, brawl, fight, shot in the head, shot in the back and revenge.

The computing device can also determine at least a genre on the plot attribute. For example, the genre can include one of: action, adventure, animation, biography, comedy, crime, documentary, drama, family, fantasy, history, horror, music, musical, history, romance, sci-fi, sport, thriller, war and western.

The computing device can collect performance measurements associated with the plot attribute. The device can also collect performance measurements associated with the plot attribute on marketing channels, wherein the marketing channels comprise at least one of: websites (such as social media websites, video sharing websites, Facebook, Youtube etc.), mobile applications (such as Instagram, Facebook App, etc.), venues (such as movie theaters, etc.), television and print.

The performance measurements can include: number of clicks, number of views, number of likes, number of shares, number of comments, number of visits, number of tweets, (positive and/or negative) feedbacks, comments, web site usage data, marketing campaign cost, production cost, advertising cost, box office revenue, and ROI. The performance measurements can be collected over a predetermined period of time.

A method for determining a plot attribute of a video/movie includes selecting a frame from among a plurality of frames in the video; generating metadata associated with the selected frame; and determining a scene type associated with the selected frame based on the generated characteristics/metadata. The method also include determining whether a preceding frame that precedes the selected frame and/or a following frame that follows the selected frame belong to the scene type.

The method also includes generating audio metadata associated with audio of the selected frame or scene type. The metadata associated with the selected frame includes: object/tool (for example, identification of a gun), condition of a character (for example, blood on face, blood on head), sound cues (for example, explosion, music, etc.).

The method also includes identifying at least one character (for example, an actor/actress) associated with the scene type and determining the number of times the at least one character appears in the video. The method further includes identifying a plurality of scenes, wherein each scene comprises neighbor frames that precede or follow the selected frame in the video; and determining a plot attribute associated with the plurality of scenes based on the metadata and/or audio metadata.

The plot attribute can include one of: action, explosion, murder, violence, pistol, death, shot in the chest, thriller, shot to death, shootout, machine gun, blood, martial arts, flashback, falling from height, chase, fistfight, hand to hand combat, adventure, punched in the face, held at gunpoint, bare chested male, rescue, knife, brawl, fight, shot in the head, shot in the back and revenge.

The method further includes determining at least a genre on the plot attribute. The genre includes one of: action, adventure, animation, biography, comedy, crime, documentary, drama, family, fantasy, history, horror, music, musical, history, romance, sci-fi, sport, thriller, war and western.

The method further includes collecting performance measurements associated with the plot attribute on marketing channels. The marketing channels can include websites (such as social media websites, video sharing websites, Facebook, Youtube etc.), mobile applications (such as Instagram, Facebook App, etc.), venues (such as movie theaters, etc.), television and print. The performance measurements include number of clicks, number of views, number of likes, number of shares, number of comments, number of visits, number of tweets, (positive and/or negative) feedbacks, comments, web site usage data, marketing campaign cost, production cost, advertising cost, box office revenue, and ROI. The performance measurements are collected over a predetermined period.

While the above description provides examples of one or more apparatus, methods, or systems, it will be appreciated that other apparatus, methods, or systems may be within the scope of the claims as interpreted by one of skill in the art.

1. A system for analyzing media asset data, the system comprising:
a memory storing a media asset data, including media expectation data, media performance data;
a user input device for receiving user input of a media characteristic;
a processor configured to generate a media performance prediction from the media expectation data, the media performance data, and the media characteristic; and
a display for displaying the media performance prediction.

2. The system of claim 1, wherein the media performance prediction includes media asset data plotted against the media expectation data and media performance data.

3. The system of claim 2, wherein the media performance prediction includes a performance prediction line bisecting the media asset data that has overperformed and underperformed.

4. The system of claim 2, wherein the user input is further configured to receive a selection of at least one media asset data point, and wherein the display displays a media title for the at least one media asset data point.

5. The system of claim 2, wherein the user input is further configured to receive a selection of a second media characteristic, and wherein the display displays a a performance success prediction indicator.

6. The system of claim 1, wherein the memory further includes media consumption data, wherein the processor is configured to generate a media consumption prediction from the media consumption data and the media performance prediction, and wherein the display displays the media consumption prediction plot.

7. The system of claim 6, wherein the media consumption prediction includes an enthusiasm index indicator.

8. The system of claim 6, wherein the media consumption prediction includes a market share indicator.

9. The system of claim 6, wherein the media consumption prediction includes a consumer geography, and wherein the media consumption plot includes a map.

10. The system of claim 6, wherein the media consumption prediction includes a consumer demographic, and wherein the media consumption plot includes a bar graph or a market asset list.

11. A method of analyzing media asset data, the method comprising:
receiving media asset data, including media expectation data, media performance data;
receiving user input of a media characteristic;
generating a media performance prediction from the media expectation data, the media performance data, and the media characteristic; and
displaying the media performance prediction.

12. The method of claim 11, wherein the media performance prediction includes media asset data plotted against the media expectation data and media performance data.

13. The method of claim 12, wherein the media performance prediction includes a performance prediction line bisecting the media asset data that has overperformed and underperformed.

14. The method of claim 12 further comprising:
receiving user input, selecting at least one media asset data point; and
displaying a media title for the at least one media asset data point.

15. The method of claim 12 further comprising:
receiving user input, selecting a second media characteristic; and
displaying a performance success prediction indicator.

16. The method of claim 11 further comprising: receiving media consumption data;
generating a media consumption prediction from the media consumption data and the media performance prediction; and
displaying the media consumption prediction plot.

17. The method of claim 16, wherein the media consumption prediction includes an enthusiasm index indicator.

18. The method of claim 16, wherein the media consumption prediction includes a market share indicator.

19. The method of claim 16, wherein the media consumption prediction includes a consumer geography, and wherein the media consumption plot includes a map.

20. The method of claim 16, wherein the media consumption prediction includes a consumer demographic, and wherein the media consumption plot includes a bar graph or a market asset list.
